(19) United States
(12) Patent Application Publication
(10) Pub. No.: US 2012/0176478 A1
(43) Pub. Date: Jul. 12, 2012

(54) FORMING RANGE MAPS USING PERIODIC ILLUMINATION PATTERNS

(76) Inventors: Sen Wang, Rochester, NY (US); Paul James Kane, Rochester, NY (US); Lulu He, Evanston, IL (US)

(21) Appl. No.: 13/004,224

(22) Filed: Jan. 11, 2011

(51) Int. Cl. H04N 13/02; G06K 9/00; H04N 7/18

(52) U.S. Cl. 348/47; 348/136; 382/154; 348/E13.074; 348/E07.085

(57) ABSTRACT

A method for determining a range map for a scene comprising: projecting a sequence of binary illumination patterns onto a scene from a projection direction; capturing a sequence of binary pattern images of the scene; projecting a sequence of periodic grayscale illumination patterns onto the scene, each periodic grayscale pattern having the same frequency and a different phase, the phase of the grayscale illumination patterns each having a known relationship to the binary illumination patterns; capturing a sequence of grayscale pattern images of the scene; analyzing the sequence of captured binary pattern images to determine coarse projected x coordinate estimates for a set of image locations; analyzing the sequence of captured grayscale pattern images to determine refined projected x coordinate estimates for the set of image locations; and forming a range map according to the refined projected x coordinate estimates.

### CROSS-REFERENCE TO RELATED APPLICATIONS

Reference is made to commonly assigned, co-pending U.S. patent application Ser. No. ______ (docket 96602), entitled: “Forming 3D models using two range maps”, by S. Wang; to commonly assigned, co-pending U.S. patent application Ser. No. ______ (docket 96603), entitled: “Forming 3D models using multiple range maps”, by S. Wang; and to commonly assigned, co-pending U.S. patent application Ser. No. ______ (docket 96604), entitled: “Forming 3D models using periodic illumination patterns”, by S. Wang, each of which is incorporated herein by reference.

### FIELD OF THE INVENTION

This invention pertains to the field of forming range maps, and more particularly to a method for forming range maps using periodic illumination patterns.

### BACKGROUND OF THE INVENTION

In recent years, applications involving three-dimensional (3D) computer models of objects or scenes have been becoming increasingly common. For example, 3D models are commonly used to create computer generated imagery for entertainment applications such as motion pictures and computer games. The computer generated imagery may be viewed in a conventional two-dimensional (2D) format, or may alternatively be viewed in 3D using stereographic imaging systems. 3D models are also used in many medical imaging applications. For example, 3D models of a human body can be produced from images captured using various types of imaging devices such as CT scanners. The formation of 3D models can also be valuable to provide information useful for image understanding applications. The 3D information can be used to aid in operations such as object recognition, object tracking and image segmentation.

With the rapid development of 3D modeling, automatic 3D shape reconstruction for real objects has become an important issue in computer vision. There are a number of different methods that have been developed for building a 3D model of a scene or an object. Some methods for forming 3D models of an object or a scene involve capturing a pair of conventional two-dimensional images from two different viewpoints. Corresponding features in the two captured images can be identified and range information (i.e., depth information) can be determined from the disparity between the positions of the corresponding features. Range values for the remaining points can be estimated by interpolating between the ranges for the determined points. A range map is a form of a 3D model which provides a set of z values for an array of (x,y) positions relative to a particular viewpoint. An algorithm of this type is described in the article “Developing 3D viewing model from 2D stereo pair with its occlusion ratio” by Johari et al. (International Journal of Image Processing, Vol. 4, pp. 251-262, 2010).

Another method for forming 3D models is known as structure from motion. This method involves capturing a video sequence of a scene from a moving viewpoint. For example, see the article “Shape and motion from image streams under orthography: a factorization method” by Tomasi et al. (International Journal of Computer Vision, Vol. 9, pp. 137-154, 1992). With structure from motion methods, the 3D positions of image features are determined by analyzing a set of image feature trajectories which track feature position as a function of time. The article “Structure from Motion without Correspondence” by Dellaert et al. (IEEE Computer Society Conference on Computer Vision and Pattern Recognition, 2000) teaches a method for extending the structure in motion approach so that the 3D positions can be determined without the need to identify corresponding features in the sequence of images. Structure from motion methods generally do not provide a high quality 3D model due to the fact that the set of corresponding features that can be identified are typically quite sparse.

Another method for forming 3D models of objects involves the use of “time of flight cameras.” Time of flight cameras infer range information based on the time it takes for a beam of reflected light to be returned from an object. One such method is described by Gokturk et al. in the article “A time-of-flight depth sensor—system description, issues, and solutions” (Proc. Computer Vision and Pattern Recognition Workshop, 2004). Range information determined using these methods is generally low in resolution (e.g., 128×128 pixels).

Other methods for building a 3D model of a scene or an object involve projecting one or more structured lighting patterns (e.g., lines, grids or periodic patterns) onto the surface of an object from a first direction, and then capturing images of the object from a different direction. For example, see the articles “Model and algorithms for point cloud construction using digital projection patterns” by Peng et al. (ASME Journal of Computing and Information Science in Engineering, Vol. 7, pp. 372-381, 2007) and “Real-time 3D shape measurement with digital stripe projection by Texas Instruments micromirror devices (DMD)” by Frankowski et al. (Proc. SPIE, Vol. 3958, pp. 90-106, 2000). A range map is determined from the captured images based on triangulation.

There are many coding strategies for structured lighting patterns. They are generally designed so that each point in the pattern can be identified, and projector-camera correspondences can easily be found. An overview of different prior art structured lighting patterns that have been developed is given by Pages et al. in the article “Overview of coded light projection techniques for automatic 3D profiling” (IEEE Conf. on Robotics and Automation, pp. 133-138, 2003). For the case where it is desired to reconstruct a 3D model of complex objects in a static scene, methods that involve temporally varying the projected structured lighting pattern are typically used. With this approach, a series of structured lighting patterns are projected onto the object sequentially and the depth for each pixel is formed by analyzing the sequence of illuminance values across the projected patterns.

One category of structured lighting patterns is based on a sequence of m binary lighting patterns as described by Posdamer et al. in the article “Surface measurement by space-encoded projected beam systems” (Computer Graphics and Image Processing, Vol. 18, pp. 1-17, 1982). Various types of binary patterns have been proposed, including the well-known “Gray code” patterns and “Hamming code” patterns. Typically, about 24 different patterns must be used to obtain adequate depth resolution. Horn et al. have disclosed extending this approach to use different grey levels in the projected patterns as described in the article “Toward optimal structured light patterns” (Image and Vision Computing, Vol. 17, pp. 87-97, 1999). This enables a reduction in the total number of structured lighting patterns that must be used.

Other structured lighting methods have involved applying phase-shifts to the projected periodic patterns to achieve an improved spatial resolution with a reduced number of patterns. However, a drawback to this approach is the phase ambiguity introduced in the analysis of the periodic patterns. Thus, phase unwrapping algorithms must be used to attempt to resolve the ambiguity. For example, Huang et al. have disclosed a phase unwrapping algorithm in the article “Fast three-step phase-shifting algorithm” (Applied Optics, vol. 45, no. 21, pp. 5086-5091, 2006). Phase unwrapping algorithms are typically computationally complex, and often produce unreliable results, particularly when there are depth abrupt changes at the edges of objects. Another approach to resolve the phase ambiguity problem, a hybrid approach has been proposed by Guhring in the article “Dense 3-D surface acquisition by structured light using off-the-shelf components” (Videometrics and Optical Methods for 3D Shape Measurement, Vol. 4309, pp. 220-231, 2001). This method combines a series of binary Gray code patterns together with phase-shifting a binary line pattern. While this method succeeded at obtaining higher accuracy, it has the disadvantage that the number of required patterns is also increased considerably.

Most techniques for generating 3D models from 2D images produce incomplete 3D models due to the fact that no information is available regarding the back sides of any objects in the captured images. Additional 2D images can be captured from additional viewpoints to provide information about portions of the objects that may be occluded from a single viewpoint. However, combining the range information determined from the different viewpoints is a difficult problem.

U.S. Pat. No. 7,551,760 to Scharlack et al., entitled “Registration of 3D imaging of 3D objects,” teaches a method to register 3D models of dental structures. The 3D models are formed from two different perspectives using a 3D scanner. The two models are aligned based on the locations of recognition objects having a known geometry (e.g., small spheres having known sizes and positions) that are placed in proximity to the object being scanned.

U.S. Pat. No. 7,801,708 to Unal et al., entitled “Method and apparatus for the rigid and non-rigid registration of 3D shapes,” teaches a method for registering two 3D shapes representing ear impression models. The method works by minimizing a function representing an energy between signed distance functions created from the two ear impression models.

U.S. Patent Application Publication 2009/0232355 to Minear et al., entitled “Registration of 3D point cloud data using eigenanalysis,” teaches a method for registering multiple frames of 3D point cloud data captured from different perspectives. The method includes a coarse registration step based on finding centroids of blob-like objects in the scene. A fine registration step is used to refine the coarse registration by applying an iterative optimization method.

There remains a need for a simple and robust method for forming 3D models based on structured lighting patterns that obtain a high degree of accuracy, while using a smaller number of projected patterns.

### SUMMARY OF THE INVENTION

The present invention represents a method for determining a range map for a scene using a digital camera, comprising:

using a projector to project a sequence of different binary illumination patterns onto a scene from a projection direction;

capturing a sequence of binary pattern images of the scene using the digital camera from a capture direction different from the projection direction, each digital image corresponding to one of the projected binary illumination patterns;

using a projector to project a sequence of periodic grayscale illumination patterns onto the scene from the projection direction, each periodic grayscale pattern having the same frequency and a different phase, the phase of the grayscale illumination patterns each having a known relationship to the binary illumination patterns;

capturing a sequence of grayscale pattern images of the scene using the digital camera from the capture direction, each digital image corresponding to one of the projected periodic grayscale illumination patterns;

wherein the projected binary illumination patterns and periodic grayscale illumination patterns share a common coordinate system having a projected x coordinate and a projected y coordinate, the projected binary illumination patterns and periodic grayscale illumination patterns varying with the projected x coordinate and being constant with the projected y coordinate;

analyzing the sequence of captured binary pattern images to determine coarse projected x coordinate estimates for a set of image locations;

analyzing the sequence of captured grayscale pattern images to determine refined projected x coordinate estimates for the set of image locations responsive to the determined coarse projected x coordinate estimates;

determining range values for the set of image locations responsive to the refined projected x coordinate estimates, wherein a range value is a distance between a reference location and a location in the scene corresponding to an image location;

forming a range map according to the refined range value estimates, the range map comprising range values for an array of image locations, the array of image locations being addressed by two-dimensional image coordinates; and

storing the range map in a processor-accessible memory system.

This invention has the advantage that high accuracy range maps can be determined using a significantly smaller number of projected patterns than conventional methods employing Gray code patterns, or other similar sequences of binary patterns. It is also advantaged relative to conventional phase shift based methods because no phase unwrapping step is required, thereby significantly simplifying the computations.

### BRIEF DESCRIPTION OF THE DRAWINGS

FIG. 1 is a high-level diagram showing the components of a system for determining three-dimensional models;

FIG. 2 is a diagram showing an arrangement for capturing images of scenes illuminated with structured lighting patterns;

FIG. 3 is a flow chart of a method for determining a range map using binary pattern images and grayscale pattern images;

FIG. 4A shows an example sequence of binary illumination patterns;

FIG. 4B shows an example sequence of periodic grayscale illumination patterns;

FIG. 5 shows an illustrative set of Gray code patterns;

FIG. 6 shows an example sequence of binary pattern images;

FIG. 7 shows an example of a coarse range map determined using the binary pattern images of FIG. 6.

FIG. 8 shows an example sequence of grayscale pattern images;

FIG. 9 shows an example range map determined using the binary pattern images of FIG. 6 and the grayscale pattern images of FIG. 8;

FIG. 10 shows an example of a point cloud 3D model determined using the range map of FIG. 9;

FIG. 11 is a diagram showing an arrangement for capturing images of a scene using multiple digital cameras and a single projector; and

FIG. 12 is a diagram showing an arrangement for capturing images of a scene using multiple digital cameras and multiple projectors.

It is to be understood that the attached drawings are for purposes of illustrating the concepts of the invention and may not be to scale.

### DETAILED DESCRIPTION OF THE INVENTION

In the following description, some embodiments of the present invention will be described in terms that would ordinarily be implemented as software programs. Those skilled in the art will readily recognize that the equivalent of such software may also be constructed in hardware. Because image manipulation algorithms and systems are well known, the present description will be directed in particular to algorithms and systems forming part of, or cooperating more directly with, the method in accordance with the present invention. Other aspects of such algorithms and systems, together with hardware and software for producing and otherwise processing the image signals involved therewith, not specifically shown or described herein may be selected from such systems, algorithms, components, and elements known in the art. Given the system as described according to the invention in the following, software not specifically shown, suggested, or described herein that is useful for implementation of the invention is conventional and within the ordinary skill in such arts.

The invention is inclusive of combinations of the embodiments described herein. References to “a particular embodiment” and the like refer to features that are present in at least one embodiment of the invention. Separate references to “an embodiment” or “particular embodiments” or the like do not necessarily refer to the same embodiment or embodiments; however, such embodiments are not mutually exclusive, unless so indicated or as are readily apparent to one of skill in the art. The use of singular or plural in referring to the “method” or “methods” and the like is not limiting. It should be noted that, unless otherwise explicitly noted or required by context, the word “or” is used in this disclosure in a non-exclusive sense.

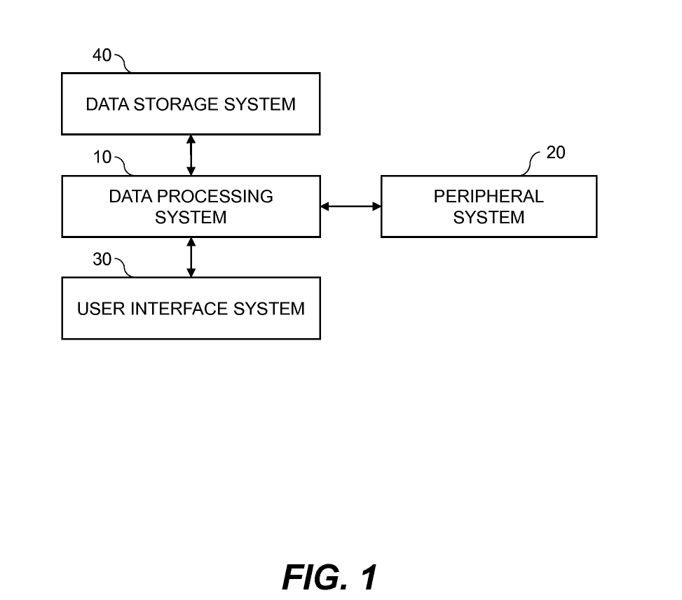

FIG. 1 is a high-level diagram showing the components of a system for determining three-dimensional models from two images according to an embodiment of the present invention. The system includes a data processing system 10, a peripheral system 20, a user interface system 30, and a data storage system 40. The peripheral system 20, the user interface system 30 and the data storage system 40 are communicatively connected to the data processing system 10.

The data processing system 10 includes one or more data processing devices that implement the processes of the various embodiments of the present invention, including the example processes described herein. The phrases “data processing device” or “data processor” are intended to include any data processing device, such as a central processing unit (“CPU”), a desktop computer, a laptop computer, a mainframe computer, a personal digital assistant, a Blackberry™, a digital camera, cellular phone, or any other device for processing data, managing data, or handling data, whether implemented with electrical, magnetic, optical, biological components, or otherwise.

The data storage system 40 includes one or more processor-accessible memories configured to store information, including the information needed to execute the processes of the various embodiments of the present invention, including the example processes described herein. The data storage system 40 may be a distributed processor-accessible memory system including multiple processor-accessible memories communicatively connected to the data processing system 10 via a plurality of computers or devices. On the other hand, the data storage system 40 need not be a distributed processor-accessible memory system and, consequently, may include one or more processor-accessible memories located within a single data processor or device.

The phrase “processor-accessible memory” is intended to include any processor-accessible data storage device, whether volatile or nonvolatile, electronic, magnetic, optical, or otherwise, including but not limited to, registers, floppy disks, hard disks, Compact Discs, DVDs, flash memories, ROMs, and RAMS.

The phrase “communicatively connected” is intended to include any type of connection, whether wired or wireless, between devices, data processors, or programs in which data may be communicated. The phrase “communicatively connected” is intended to include a connection between devices or programs within a single data processor, a connection between devices or programs located in different data processors, and a connection between devices not located in data processors at all. In this regard, although the data storage system 40 is shown separately from the data processing system 10, one skilled in the art will appreciate that the data storage system 40 may be stored completely or partially within the data processing system 10. Further in this regard, although the peripheral system 20 and the user interface system 30 are shown separately from the data processing system 10, one skilled in the art will appreciate that one or both of such systems may be stored completely or partially within the data processing system 10.

The peripheral system 20 may include one or more devices configured to provide digital content records to the data processing system 10. For example, the peripheral system 20 may include digital still cameras, digital video cameras, cellular phones, or other data processors. The data processing system 10, upon receipt of digital content records from a device in the peripheral system 20, may store such digital content records in the data storage system 40.

The user interface system 30 may include a mouse, a keyboard, another computer, or any device or combination of devices from which data is input to the data processing system 10. In this regard, although the peripheral system 20 is shown separately from the user interface system 30, the peripheral system 20 may be included as part of the user interface system 30.

The user interface system 30 also may include a display device, a processor-accessible memory, or any device or combination of devices to which data is output by the data processing system 10. In this regard, if the user interface system 30 includes a processor-accessible memory, such memory may be part of the data storage system 40 even though the user interface system 30 and the data storage system 40 are shown separately in FIG. 1.

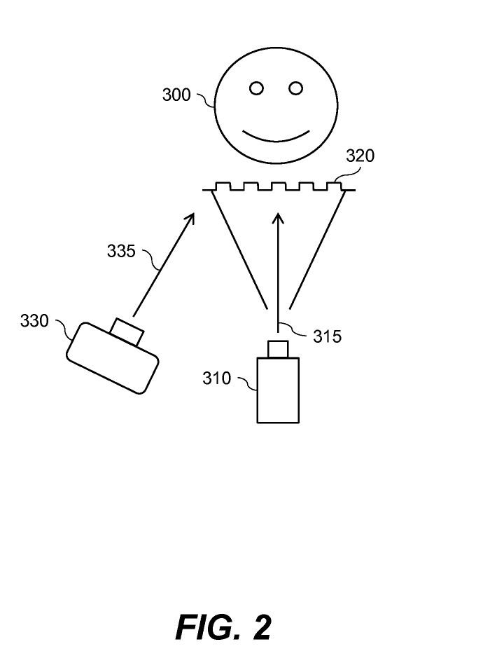

FIG. 2 shows an arrangement for capturing images of projected structured lighting patterns that can be used in accordance with the present invention. A projector 310 is used to project an illumination pattern 320 onto an object 300 from a projection direction 315. An image of the object 300 is captured using a digital camera 330 from a capture direction 335. The capture direction 335 is different from the projection direction 315 in order to provide depth information according to the parallax effect. As will be described in more detail later, a sequence of different illumination patterns 320 are projected in accordance with the present invention, and an image is captured corresponding to each of the projected illumination patterns.

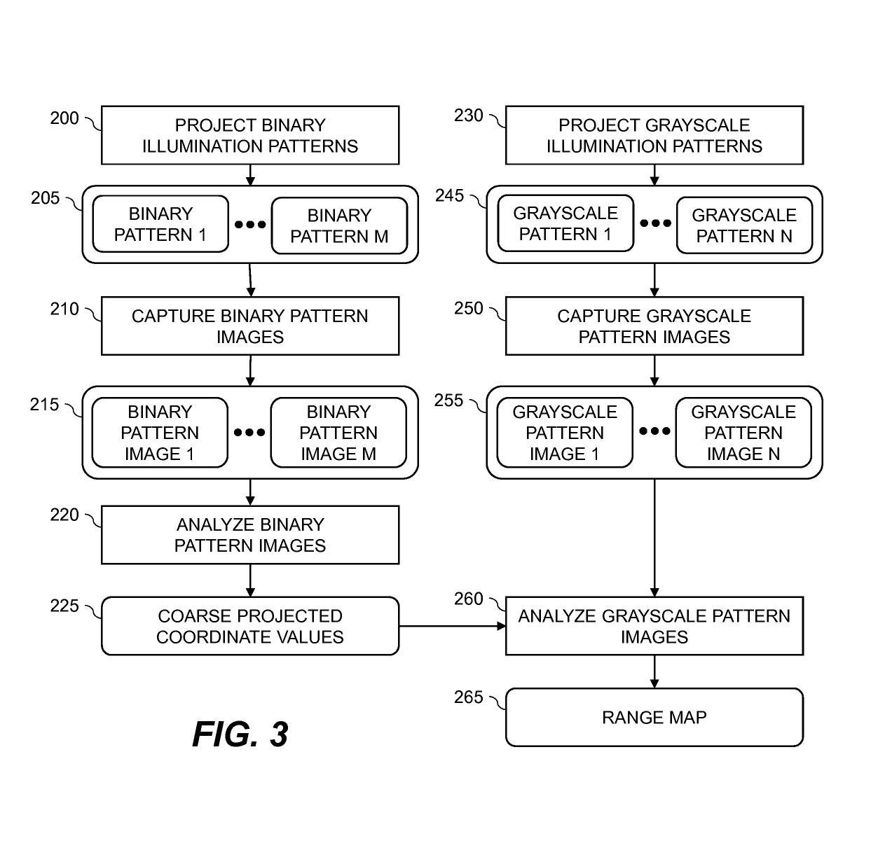

FIG. 3 shows a flowchart of a method for determining a range map 265 for a scene according to one embodiment. A project binary illumination patterns step 200 is used to project a sequence of M binary illumination patterns 205 onto the scene from a projection direction. A capture binary pattern images step 210 is used to capture a set of M binary pattern images 215, each binary pattern image 215 corresponding to one of the projected binary illumination patterns 205.

An analyze binary pattern images step 220 is used to analyze the binary pattern images 215 to determine coarse projected coordinate values 225 for each pixel location in the captured binary pattern images 215. The coarse projected coordinate values 225 are initial estimates of locations in the projected illumination patterns that correspond to the pixel locations in the captured binary pattern images 215. Generally, the larger the number M of binary illumination patterns 205, the more accurate the estimated coarse projected coordinate values 225 will be.

A project grayscale illumination patterns step 230 is used to project a sequence of N periodic grayscale illumination patterns 245 onto the scene from the projection direction. In a preferred embodiment, each of the N periodic grayscale illumination pattern 245 has a spatial frequency determined in accordance with the binary illumination patterns 205 as will be described later. Each of the N grayscale illumination patterns 245 has a different phase, the N phases each having a known relationship to the binary illumination patterns 205. A capture grayscale pattern images step 250 is used to capture a set of N grayscale pattern images 255, each grayscale pattern image 255 corresponding to one of the projected grayscale illumination patterns 245.

An analyze grayscale pattern images step 260 is used to analyze the grayscale pattern images 255 to determine the range map 265, responsive to the determined coarse projected coordinate values 225. The range map 265 gives range values for an array of locations in the scene. As used herein, a range value is the distance between a reference location and a location in the scene corresponding to an image location. Typically, the reference location is the location of the digital camera 330 (FIG. 2). Generally, the array of locations in the scene will correspond to the pixel locations in the captured binary pattern images 215 and the grayscale pattern images 255, although this is not required. The determined range map 265 is stored in a processor-accessible memory system for later use. The processor-accessible memory system can be any form of digital memory such as a RAM or a hard disk, as was discussed relative to the data storage system 40 of FIG. 1.

The sequence of binary illumination patterns 205 can be defined using any method known in the art in a manner such that an analysis of the binary pattern images 215 provides information about the corresponding location in the projected binary illumination patterns 205. In a preferred embodiment, the binary illumination patterns 205 are the well-known “Gray code” patterns, such as those described in the aforementioned article by Posdamer et al. entitled “Surface measurement by space-encoded projected beam systems.” A sequence of 5 to 6 binary illumination patterns 205 has been found to produce reasonable results according to the method of the present invention. Additionally, it is often useful to capture an image where the projected image is totally black to provide a black reference against which each of the captured binary pattern images 215 and grayscale pattern images 255 can be compared, and another image where the projected image is totally white to provide a true color image which can be used to provide color data for the 3D model.

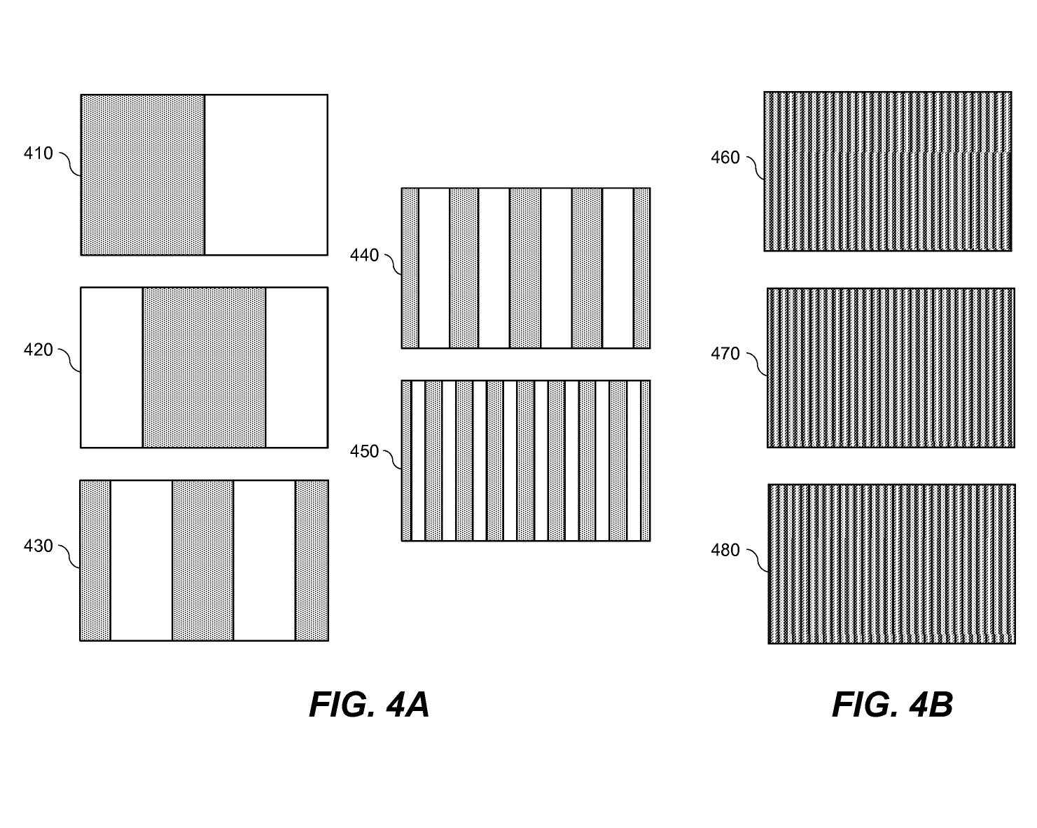

FIG. 4A shows a sequence of 5 Gray code binary illumination patterns 410, 420, 430, 440 and 450, that can be used for the binary illumination patterns 205 according to one embodiment. It can be seen that each of the Gray code patterns is a binary periodic pattern having a specified spatial frequency and phase. In other embodiments, different binary illumination patterns 205 can be used such as binary tree patterns or the well-known Hamming code patterns.

FIG. 4B shows a sequence of three sinusoidal grayscale illumination patterns 460, 470 and 480, which can be used for the grayscale illumination patterns 245 according to one embodiment. Each of the sinusoidal grayscale illumination patterns 460, 470 and 480 is identical, except that they each have a different phase. The phase for the sinusoidal grayscale illumination patterns 470 is shifted by ⅓ of a period relative to the phase of the sinusoidal grayscale illumination patterns 460, and the phase for the sinusoidal grayscale illumination patterns 480 is shifted by ⅔ of a period relative to the phase of the sinusoidal grayscale illumination patterns 460. In other embodiments, different sequences of grayscale illumination patterns 245. For example, different periodic waveforms can be used that are not sinusoidal, such as triangular waveforms.

The total number of images that are captured according to the preferred embodiment include 5 binary pattern images 215, 3 grayscale pattern images 255, a black reference image and a full color image, for a total of 10 images. This is a much smaller number than would be required to obtain adequate resolution with the conventional Gray code approach, where 24 or more images are typically captured.

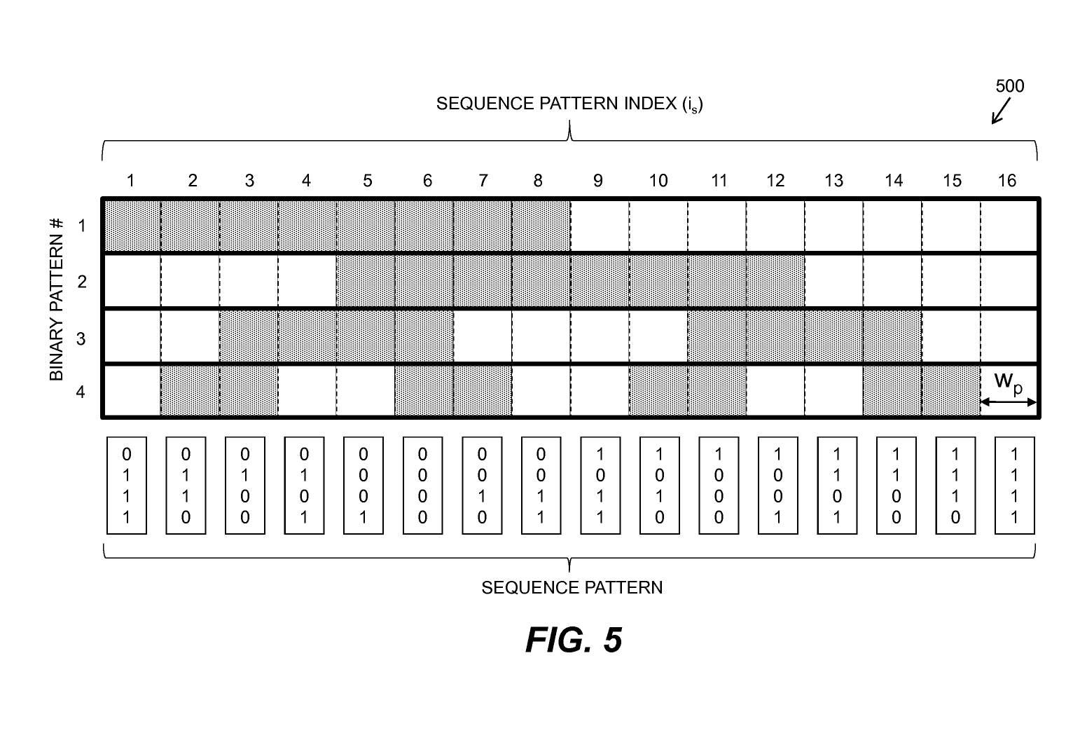

The analyze binary pattern images step 220 analyzes the binary pattern images 215 to determine coarse projected coordinate values 225 for each pixel location in the image. Methods for analyzing a sequence of binary pattern images 215 corresponding to Gray code patterns to determine such projected coordinate values are well known in the art. FIG. 5 illustrates some of the features of Gray code patterns that can be used to determine the coarse projected coordinate values 225. For this illustration, a set of four binary Gray code patterns 500 are used, labeled as binary patterns #1-4. For binary pattern #1, the left half of the projected binary illumination pattern is black, and the right half of the projected binary illumination pattern is white. Each of the other binary illumination patterns is comprised of black and white regions of different sizes. For example, binary pattern #4 is a periodic pattern having 4 black regions.

Depending on the location of a particular point in the scene, it will be illuminated by a different sequence of black and white illuminations as the sequence of binary illumination patterns is projected onto the scene. Generally, if a sequence of M binary illumination patterns is used, there will be 2^{M} different sequence patterns. In FIG. 5, it can be seen that there are 2⁴=16 different sequence patterns (labeled with sequence pattern indices 1-16), each having a width wₚ. For example, an object in the scene that falls within the far left region of the binary illumination patterns will be illuminated with sequence pattern (0, 1, 1, 1) identified with sequence pattern index iₛ=1, such that it will be illuminated with black in binary pattern #1 and white in binary patterns #2-4. The sequence pattern for each pixel location in the captured binary pattern images 215 (FIG. 3) can be analyzed to identify the corresponding sequence pattern index. This provides information about the relative position of the object within the projected illumination pattern, thus providing a coarse estimate of the projected x coordinate value. However, knowing the sequence pattern index can only locate the position within the illumination pattern to an accuracy equal to the width of the sequence pattern regions (wₚ) in the Gray code pattern. (This is why it is generally necessary to use a large number of gray patterns in order to determine the range with a high degree of accuracy using conventional Gray pattern methods.)

The range value for a particular pixel location can be determined using well-known parallax relationships given the pixel location in the captured image as characterized by image coordinate values (xᵢ, yᵢ), and the corresponding location in the projected image as characterized by projected coordinate values (xₚ, yₚ), together with information about the relative positions of the projector 310 (FIG. 2) and the digital camera 330 (FIG. 2). Well-known calibration methods can be used to determine a range function f_{z}(xᵢ, yᵢ, xₚ, yₚ) which relates the corresponding pixel coordinate values in the captured and projected images to the range value, z:

z=f_{z}(xᵢ,yᵢ,xₚ,yₚ). (1)

An example of a calibration method for determining such a functional relationship is given in the aforementioned article by Posdamer et al. entitled “Surface measurement by space-encoded projected beam systems.”

Using exclusively the binary pattern images 215, the only pixel locations for which ranges can be determined with a relatively high degree of accuracy are those which correspond to boundaries between different sequence patterns. A given row of the captured image can be analyzed to determine the locations of the transitions between each of the sequence patterns. Corresponding range values for the pixels located at the transition locations can be determined using Eq. (1) based on the coordinate values of the transition points in the captured binary pattern images (xᵢₜ, yᵢₜ) and the corresponding transition points in the binary illumination patterns (xₚₜ, yₚₜ). However, it is not possible to determine accurate range values for pixel locations between the transition points.

Coarse estimates for the range values for the pixel locations in the captured images between the transition points can be determined by calculating a range value for each pixel location using the actual pixel coordinate values in the captured images (xᵢ, yᵢ), and using the coordinate values for the transition location at the edge of the sequence pattern (xₚₜ, yₚₜ) as a coarse estimate for the projected coordinate values. (Note that it will generally be assumed that yₚ=yᵢ since the projected patterns are independent of y.) As will be discussed later, a more accurate estimate of the projected coordinate values can be determined by using the grayscale pattern images 245 (FIG. 3)

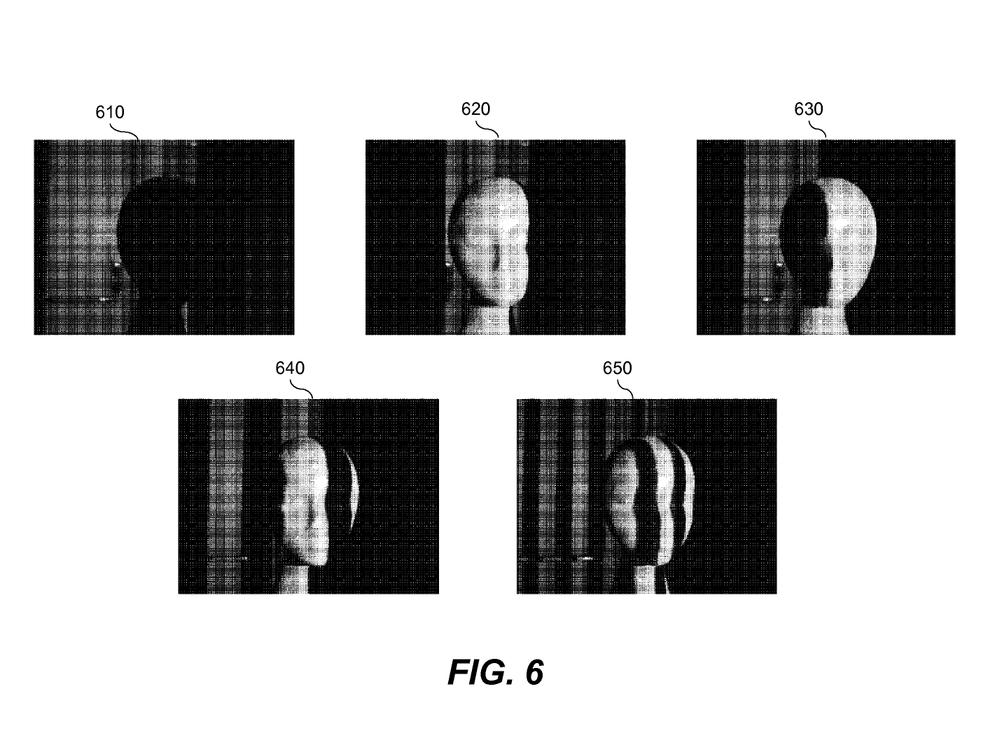

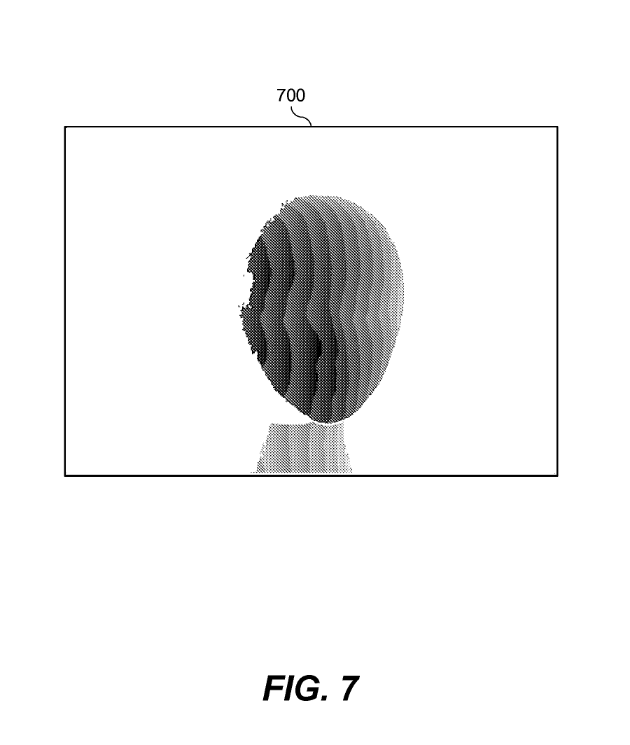

FIG. 6 shows an example of a sequence of five binary pattern images 610, 620, 630, 640 and 650 of a scene including a mannequin head using the set of Gray code binary illumination patterns shown in FIG. 4A. Analyzing the binary pattern images 610, 620, 630, 640 and 650 as described above, a coarse range value can be determined for each pixel location. FIG. 7 shows a coarse range map 700 determined in this way. The coarse range map 700 is encoded such that the tone level represents the range value, where darker tone levels correspond to smaller range values (i.e., scene points that are closer to the camera.) A series of bands can be seen across the coarse range map 700. Each band corresponds to one of the sequence patterns in the projected Gray code patterns. The range values will be accurate along the left edge of band, but will be inaccurate in the interior of the bands.

The sequence of grayscale illumination patterns 245 can be defined using any method known in the art. In a preferred embodiment, the grayscale illumination patterns 245 are periodic sinusoidal patterns having a period equal to the width of the sequence pattern regions (wₚ), and a sequence of different phases, wherein the phases of each of the periodic sinusoidal patterns have a known relationship to each other, and to the binary illumination pattern 205. (For Gray code patterns, it can be seen that this corresponds to a frequency which is 4× the frequency of the highest frequency binary illumination pattern 205 since each Gray code sequence pattern region is ¼ of the binary pattern period as can be seen from FIG. 5.)

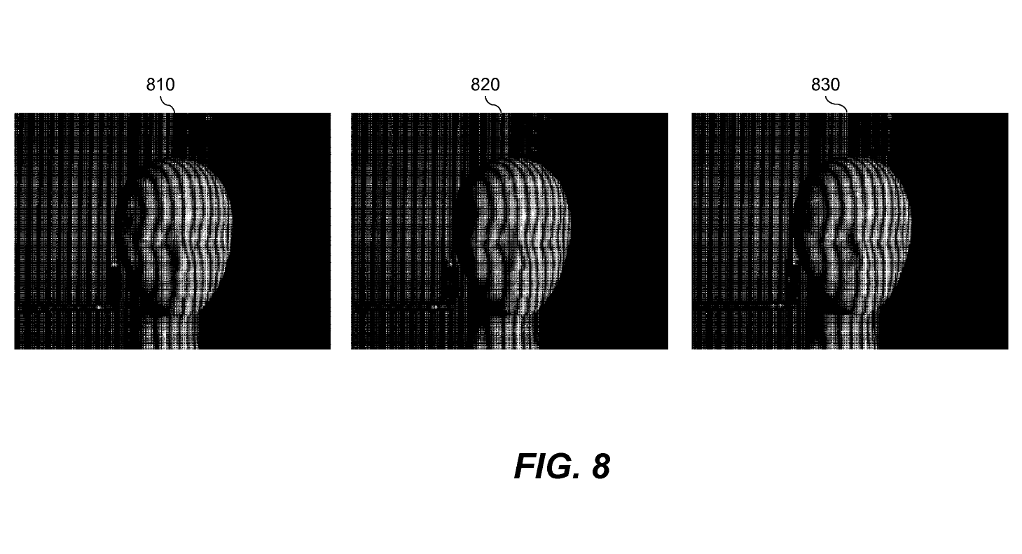

FIG. 8 shows an example of a sequence of three grayscale pattern images 810, 820 and 830 captured using capture grayscale pattern images step 250 (FIG. 3) using the set of periodic grayscale illumination patterns shown in FIG. 4B. The grayscale pattern images 810, 820 and 830 are analyzed using the analyze grayscale pattern images step 260 (FIG. 3) to determine the range map 265. In a preferred embodiment, the periodic grayscale illumination patterns can be represented in equation form as follows:

I₁(x,y)=I′(x,y)+I″(x,y)cos [φ(x,y)−2π/3] (2)

I₂(x,y)=I′(x,y)+I″(x,y)cos [φ(x,y)] (3)

I₃(x,y)=I′(x,y)+I″(x,y)cos [φ(x,y)+2π/3] (4)

where I′(x,y) is the average intensity pattern, I″(x,y) is the amplitude of the intensity modulation, and φ(x,y) is the phase at a particular pixel location. It can be seen that the phase of the second pattern I₂(x,y) is shifted by ⅓ of a period (2π/3) relative to the first pattern I₁(x,y), and the phase of the third pattern I₃(x,y) is shifted by ⅔ of a period (4π/3) relative to the first pattern I₁(x,y). The phase value at a certain position can be determined by solving Eqs. (1)-(3) for φ(x,y):

$$φ ( x , y ) = arctan [ \frac{\sqrt{3} ( {I}_{1} ( x , y ) - {I}_{3} ( x , y ) )}{2 {I}_{2} ( x , y ) - {I}_{1} ( x , y ) - {I}_{3} ( x , y )} ] \qquad ( 5 )$$

The phase of the sinusoidal patterns in the captured images will vary horizontally due to the sinusoidal pattern, but it will also vary as a function of the range due to the parallax effect. Therefore, there will be many different range values that will map to the same phase. This produces ambiguity which conventionally must be resolved using phase unwrapping algorithms. However, in the present invention, the ambiguity is resolved by using the coarse projected coordinate values determined from the binary pattern images.

In a preferred embodiment, the phase of the projected sinusoidal grayscale patterns will have a known relationship to the projected binary Gray code patterns. In particular, the phase of the projected grayscale patterns is arranged such that the maximum (i.e., the crest of the waveform) for one of the patterns (e.g., I₂(x,y)) is aligned with the transitions between the sequence pattern regions in the Gray code patterns. In this way, the zero phase points will correspond to the transition points between the bands in FIG. 7. The phase will increase across the bands and will reach a value of 2π at the right edge of the bands. Therefore, the x coordinate value in the projected image (xₚ) corresponding to a given position in the captured image can be calculated as follows:

$${x}_{p} = {x}_{pt} + \frac{φ ( {x}_{i} , {y}_{i} )}{2 π} {w}_{p} \qquad ( 6 )$$

where wₚ is the width of the Gray code sequence pattern in the projected image (see FIG. 5). In some embodiments, the coarse projected coordinate values are represented by sequence pattern indices, iₛ. In this case, the coarse projected x coordinate value can be calculated by xₚ=(iₛ−1)·wₚ.

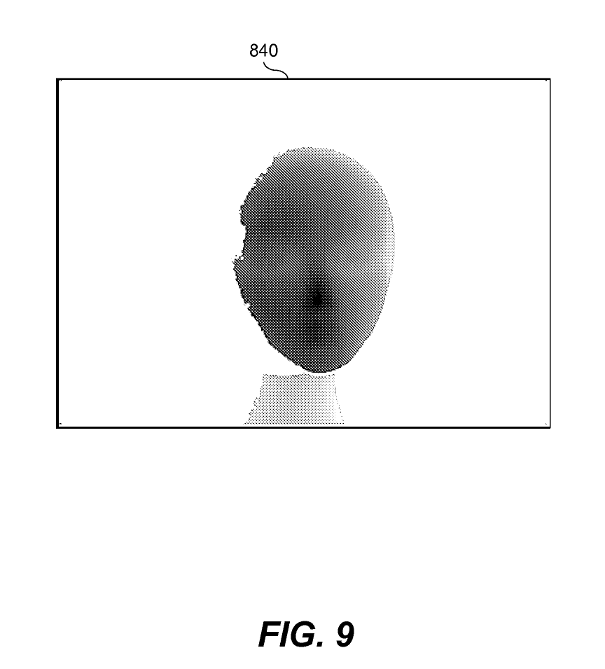

The refined estimate for the projected image position (xₚ) can then be used in Eq. (1) to obtain a refined estimate for the range value. FIG. 9 shows a range map 840 determined in this fashion responsive to the coarse projected coordinate values and the grayscale pattern images 810, 820 and 830.

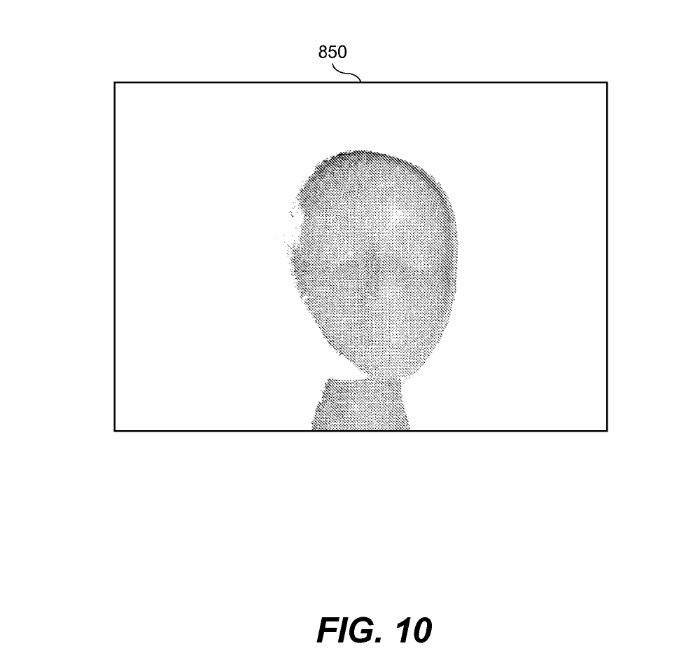

Range maps 265 (FIG. 3) determined according to the method of the present invention can be used for a variety of purposes. For some applications, it will be useful to build a 3D model of the scene, or of an object in the scene. The 3D model can take a variety of forms. One form of 3D model is known as a “point cloud” model, which is comprised of a cloud of points specified by XYZ coordinates. In some embodiments, a set of 3D XYZ coordinates for the scene can be determined by combining the 2D XY image coordinates for each point in the range map 265 with the corresponding range value, which defines a Z coordinate. In some cases, a coordinate transformation can be applied to the 3D XYZ coordinates to transform from the camera coordinate system to some arbitrary “world” coordinate system. FIG. 10 shows a point cloud 3D model 850 determined from the range map shown in FIG. 9.

In many applications, it is useful to know not only the three-dimensional shape of the object, but also to associate a color value with each point of the object. In one embodiment, color values are determined by capturing a full color image of the scene using the digital camera. To capture the full color image, the projector can be used to illuminate the scene with a full-on white pattern. Alternately, other illumination sources can be used to illuminate the scene. Color values (e.g., RGB color values) can be determined for each pixel location, and can be associated with the corresponding 3D points.

In some embodiments the point cloud 3D model can be processed to reduce noise and to produce other forms of 3D models. For example, many applications for 3D models use 3D models that are in the form of a triangulated mesh of points. Methods for forming such triangulated 3D models are well-known in the art. In some embodiments, the point cloud is re-sampled to remove redundancy and smooth out noise in the XYZ coordinates. A set of triangles are then formed connecting the re-sampled points using a method such as the well-known Delaunay triangulation algorithm. Additional processing steps can be used to perform mesh repair in regions where there are holes in the mesh or to perform other operations such as smoothing.

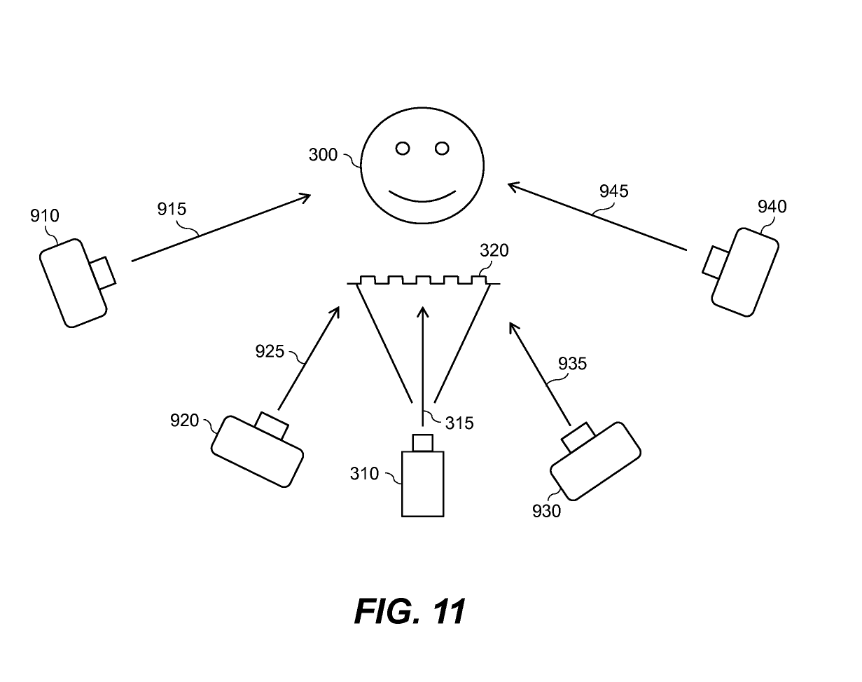

Building a 3D model of an object using images captured from a single capture direction will produce only a partial 3D model including only one side of the object. In many applications, it will be desirable to extend the 3D model by capturing images from additional capture directions in order to provide an extended angular range. FIG. 11 shows an arrangement that includes a single projector 310 which projects illumination patterns 320 onto object 300 from projection direction 315. Images are then captured using a plurality of digital cameras 910, 920, 930 and 940, from capture directions 915, 925, 935 and 945, respectively.

In one embodiment, the projector 310 sequentially projects each of the binary illumination patterns 205 (FIG. 3) and the grayscale illumination patterns 245 (FIG. 3) and images are captured of each illumination pattern with each of the digital cameras 910, 920, 930 and 940. The images captured with a specific digital camera are then processed according to the method shown in FIG. 3 to produce a range map 265 corresponding to the capture direction for that digital camera. The set of range maps can then be combined to form a single 3D model. In other embodiments, a single digital camera is used to capture images using each of the illumination patterns, then the digital camera can be moved to a new position and a second set of images can be captured.

The set of range maps determined from the different capture directions can be combined to form a single 3D model using any method known in the art. For example, each of the range maps can be converted to point cloud 3D models as was described earlier, then the individual point cloud 3D models can be combined using the method described by Minear et al. in U.S. Patent Application Publication 2009/0232355, entitled “Registration of 3D point cloud data using eigenanalysis.” In a preferred embodiment, the range maps can be combined using the method taught in co-pending, commonly assigned U.S. patent application Ser. No. ______ (docket 96603), entitled: “Forming 3D models using multiple range maps”, by S. Wang, which is incorporated herein by reference. With this method, a three-dimensional model is formed from a plurality of images, each image being captured from a different viewpoint and including a two-dimensional image together with a corresponding range map. A plurality of pairs of received images are designated, each pair including a first image and a second image. For each of the designated pairs a geometric transform is determined by identifying a set of corresponding features in the two-dimensional images; removing any extraneous corresponding features to produce a refined set of corresponding features; and determining a geometrical transformation for transforming three-dimensional coordinates for the first image to three-dimensional coordinates for the second image responsive to three-dimensional coordinates for the refined set of corresponding features. A three-dimensional model is then determined responsive to the received images and the geometrical transformations for the designated pairs of received images.

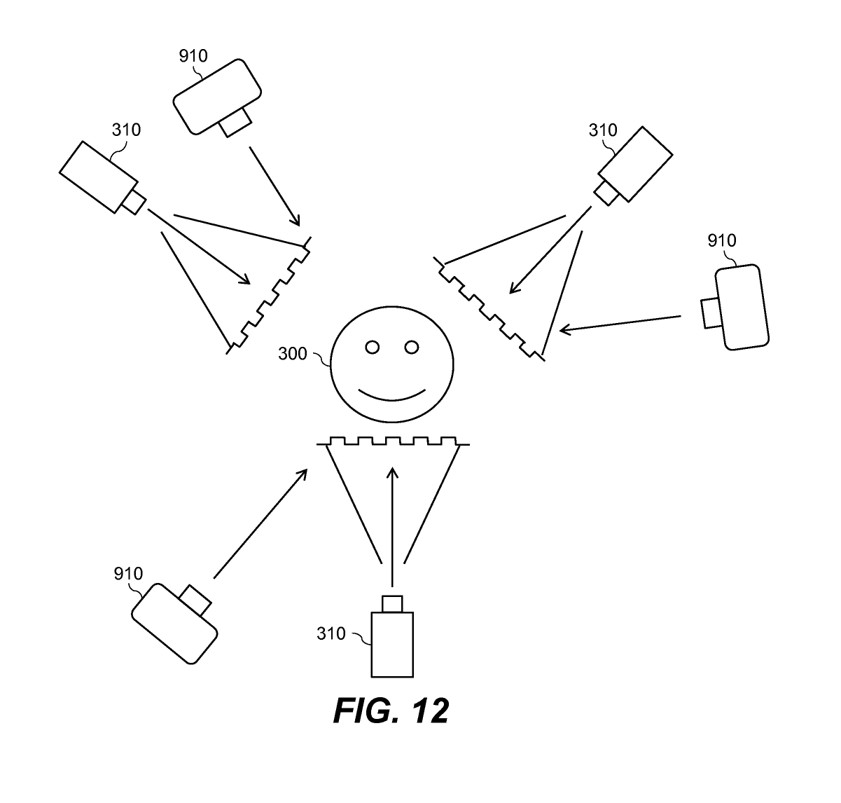

While a 3D model having an extended view can be obtained using the arrangement of FIG. 11, it can be seen that the 3D model will still be incomplete because the projector 310 can only project illumination patterns 320 onto one side of the object 300. An alternate arrangement is shown in FIG. 12 where multiple projectors 310 and digital cameras 910 are arranged around the object so that a complete 3D model can be formed. Generally, only one projector would be used to illuminate the object 300 at any given time, and then images would be captured using one or more of the digital cameras 910.

In alternate embodiments, each projector 310 can illuminate the object 300 with a different color light (e.g., red, green and blue) and so that the projectors can all be used simultaneously to illuminate the object 300. The analyze binary pattern images step 220 (FIG. 3) and the analyze grayscale pattern images step 260 (FIG. 3) can analyze the images captured by a particular camera to isolate the patterns from only one of the projectors 310 according to the color of the pattern.

A computer program product can include one or more non-transitory, tangible, computer readable storage medium, for example; magnetic storage media such as magnetic disk (such as a floppy disk) or magnetic tape; optical storage media such as optical disk, optical tape, or machine readable bar code; solid-state electronic storage devices such as random access memory (RAM), or read-only memory (ROM); or any other physical device or media employed to store a computer program having instructions for controlling one or more computers to practice the method according to the present invention.

The invention has been described in detail with particular reference to certain preferred embodiments thereof, but it will be understood that variations and modifications can be effected within the spirit and scope of the invention.

### PARTS LIST

10 data processing system
20 peripheral system
30 user interface system
40 data storage system
200 project binary illumination patterns step
205 binary illumination patterns
210 capture binary pattern images step
215 binary pattern images
220 analyze binary pattern images step
225 coarse projected coordinate values
230 project grayscale illumination patterns step
245 grayscale illumination patterns
250 capture grayscale pattern images step
255 grayscale pattern images
260 analyze grayscale pattern images step
265 range map
300 object
310 projector
315 projection direction
320 illumination pattern
330 digital camera
335 capture direction
410 Gray code binary illumination pattern
420 Gray code binary illumination pattern
430 Gray code binary illumination pattern
440 Gray code binary illumination pattern
450 Gray code binary illumination pattern
460 sinusoidal grayscale illumination pattern
470 sinusoidal grayscale illumination pattern
480 sinusoidal grayscale illumination pattern
500 Gray code patterns
610 binary pattern image
620 binary pattern image
630 binary pattern image
640 binary pattern image
650 binary pattern image
700 coarse range map
810 grayscale pattern image
820 grayscale pattern image
830 grayscale pattern image
840 range map
850 point cloud 3D model
910 digital camera
915 capture direction
920 digital camera
925 capture direction
920 digital camera
935 capture direction
940 digital camera
945 capture direction

1. A method for determining a range map for a scene using a digital camera, comprising:
using a projector to project a sequence of different binary illumination patterns onto a scene from a projection direction;
capturing a sequence of binary pattern images of the scene using the digital camera from a capture direction different from the projection direction, each digital image corresponding to one of the projected binary illumination patterns;
using a projector to project a sequence of periodic grayscale illumination patterns onto the scene from the projection direction, each periodic grayscale pattern having the same frequency and a different phase, the phase of the grayscale illumination patterns each having a known relationship to the binary illumination patterns;
capturing a sequence of grayscale pattern images of the scene using the digital camera from the capture direction, each digital image corresponding to one of the projected periodic grayscale illumination patterns;
wherein the projected binary illumination patterns and periodic grayscale illumination patterns share a common coordinate system having a projected x coordinate and a projected y coordinate, the projected binary illumination patterns and periodic grayscale illumination patterns varying with the projected x coordinate and being constant with the projected y coordinate;
analyzing the sequence of captured binary pattern images to determine coarse projected x coordinate estimates for a set of image locations;
analyzing the sequence of captured grayscale pattern images to determine refined projected x coordinate estimates for the set of image locations responsive to the determined coarse projected x coordinate estimates;
determining range values for the set of image locations responsive to the refined projected x coordinate estimates, wherein a range value is a distance between a reference location and a location in the scene corresponding to an image location;
forming a range map according to the refined range value estimates, the range map comprising range values for an array of image locations, the array of image locations being addressed by two-dimensional image coordinates; and
storing the range map in a processor-accessible memory system.

2. The method of claim 1 wherein the binary illumination patterns are Gray code patterns.

3. The method of claim 1 wherein the periodic grayscale illumination patterns are sinusoidal waveforms or triangular waveforms.

4. The method of claim 1 wherein the sequence of binary illumination patterns define a set of projected image regions of width wₚ that can be identified by analyzing the sequence of binary pattern images, and wherein the periodic grayscale illumination patterns have a period equal to the width wₚ.

5. The method of claim 4 wherein a zero phase position for one of the periodic grayscale illumination patterns is aligned with boundaries between the projected image regions.

6. The method of claim 4 wherein the sequence of captured binary pattern images are analyzed to associate the locations in the scene with one of the projected image regions to provide the coarse projected x coordinate estimates.

7. The method of claim 6 wherein the coarse projected x coordinate estimates are represented by indices identifying the associated projected image regions.

8. The method of claim 6 wherein the refined projected x coordinate estimates are determined by analyzing the captured grayscale pattern images to determine a relative location within the associated projected image region.

9. The method of claim 8 wherein the refined projected x coordinate estimates are determined by analyzing the captured grayscale pattern images to determine a phase value, and wherein the phase value is used to determine the relative location within the associated projected image region.

10. The method of claim 8 wherein the range values are determined by using a range function which relates an image location and a corresponding projected x coordinate to a corresponding range value, the range function being determined according to the relative positions of the projector and the digital camera.

11. The method of claim 1 further including the step of forming a three-dimensional model of the scene responsive to the range map.

12. The method of claim 11 wherein the range values in the range map are combined with the corresponding two-dimensional image coordinates to provide three-dimensional coordinates for the three-dimensional model.

13. The method of claim 11 wherein color values for the three-dimensional model are determined by capturing a full color image of the scene using the digital camera.

14. The method of claim 11 further including combining three-dimensional models determined using digital cameras positioned at different capture directions to determine a combined three-dimensional model.

15. A system comprising:
a projection system for projecting illumination patterns onto a scene from a projection direction;
a digital camera having an associated capture direction, the capture direction being different from the projection direction;
a data processing system;
a processor-accessible memory system communicatively connected to the data processing system; and
a program memory system communicatively connected to the data processing system and storing instructions configured to cause the data processing system to implement a method for determining a range map, wherein the instructions comprise:
using the projection system to project a sequence of different binary illumination patterns onto a scene;
capturing a sequence of binary pattern images of the scene using the digital camera, each digital image corresponding to one of the projected binary illumination patterns;
using the projection system to project a sequence of periodic grayscale illumination patterns onto the scene from the projection direction, each periodic grayscale pattern having the same frequency and a different phase, the phase of the grayscale illumination patterns having a known relationship to the binary illumination patterns;
capturing a sequence of grayscale pattern images of the scene using the digital camera, each digital image corresponding to one of the projected periodic grayscale illumination patterns;
wherein the projected binary illumination patterns and periodic grayscale illumination patterns share a common coordinate system having a projected x coordinate and a projected y coordinate, the projected binary illumination patterns and periodic grayscale illumination patterns varying with the projected x coordinate and being constant with the projected y coordinate;
analyzing the sequence of captured binary pattern images to determine coarse projected x coordinate estimates for a set of image locations,
analyzing the sequence of captured grayscale pattern images to determine refined projected x coordinate estimates for the set of image locations responsive to the determined coarse projected x coordinate estimates;
determining range values for the set of image locations responsive to the refined projected x coordinate estimates, wherein a range value is a distance between a reference location and a location in the scene corresponding to an image location;
forming a range map according to the refined range value estimates, the range map comprising range values for an array of image locations, the array of image locations being addressed by two-dimensional image coordinates; and
storing the range map in the processor-accessible memory system.

16. A computer program product for determining a range map for a scene comprising a non-transitory tangible computer readable storage medium storing an executable software application for causing a data processing system to perform the steps of:
using a projector to project a sequence of different binary illumination patterns onto a scene from a projection direction;
capturing a sequence of binary pattern images of the scene using the digital camera from a capture direction different from the projection direction, each digital image corresponding to one of the projected binary illumination patterns;
using a projector to project a sequence of periodic grayscale illumination patterns onto the scene from the projection direction, each periodic grayscale pattern having the same frequency and a different phase, the phase of the grayscale illumination patterns having a known relationship to the binary illumination patterns;
wherein the projected binary illumination patterns and periodic grayscale illumination patterns share a common coordinate system having a projected x coordinate and a projected y coordinate, the projected binary illumination patterns and periodic grayscale illumination patterns varying with the projected x coordinate and being constant with the projected y coordinate;
capturing a sequence of grayscale pattern images of the scene using the digital camera from the capture direction, each digital image corresponding to one of the projected periodic grayscale illumination patterns;
analyzing the sequence of captured binary pattern images to determine coarse projected x coordinate estimates for a set of image locations,
analyzing the sequence of captured grayscale pattern images to determine refined projected x coordinate estimates for the set of image locations responsive to the determined coarse projected x coordinate estimates;
determining range values for the set of image locations responsive to the refined projected x coordinate estimates, wherein a range value is a distance between a reference location and a location in the scene corresponding to an image location;
forming a range map according to the refined range value estimates, the range map comprising range values for an array of image locations, the array of image locations being addressed by two-dimensional image coordinates; and
storing the range map in a processor-accessible memory system.
